(19) United States
(12) Patent Application Publication
(10) Pub. No.: US 2008/0125900 A1
(43) Pub. Date: May 29, 2008

(54) METHOD AND APPARATUS FOR SCHEDULING MATERIAL TRANSPORT IN A SEMICONDUCTOR MANUFACTURING FACILITY

(76) Inventors: Carmen A. Maxim, Austin, TX (US); Achim Felber, San Leanna, TX (US)

Correspondence Address: MARK W. SINCELL;Williams, Morgan & Amerson, P.C., Suite 1100, 10333 Richmond, Houston, TX, 77042, US

(21) Appl. No.: 11/532,278

(22) Filed: Sep. 15, 2006

(51) Int. Cl. G06F 19/00

(52) U.S. Cl. 700/113

(57) ABSTRACT

The present invention provides a method, an apparatus, and a semiconductor manufacturing facility. The method includes receiving a request to move material from a first location to a second location in the semiconductor manufacturing facility, accessing information indicative of a duration of the move from the first location to the second location, and scheduling the requested move based on the information indicative of the duration of the move.

### BACKGROUND OF THE INVENTION

1. Field of the Invention

This invention relates generally to semiconductor processing and, more particularly, to scheduling material transport during semiconductor processing.

2. Description of the Related Art

A semiconductor fabrication facility typically includes numerous processing tools used to fabricate semiconductor devices. The processing tools may include photolithography steppers, etch tools, deposition tools, polishing tools, rapid thermal processing tools, ion implantation tools, and the like. Wafers (or wafer lots) are processed in the tools in a predetermined order and each processing tool modifies the wafers according to a particular product design and/or operating recipe so that a desired product is formed in or on the wafer. For example, a photolithography stepper may be used to form a patterned layer of photoresist above the wafer. Features in the patterned layer of photoresist correspond to a plurality of features, e.g. gate electrode structures, which will ultimately be formed above the surface of the wafer.

Operation of the processing tools in the semiconductor fabrication facility is generally controlled by a variety of control units, each of which is responsible for a different aspect of the fabrication process. For example, the semiconductor fabrication facility typically includes an Automated Material Handling System (AMHS) that is responsible for providing necessary materials to the processing tools. The AMHS typically includes controlling software such as a material control system. The materials controlled by the AMHS may include wafers, test wafers, carriers for the wafers, chemicals and/or gases used in the processing of the wafers, and the like. The material control system typically keeps track of available processing resources, carriers, and destination load ports. The AMHS also includes a manufacturing execution system that may schedule movement of wafers to and from ports in the processing tools via a host interface of the material control system. For example, the manufacturing execution system may receive a request to move a carrier that carries one or more wafers from a processing tool port to a stocker or vice versa. The manufacturing execution system may then provide a move command to the material control system in response to the move request. For example, a move command may indicate that a first carrier is to be moved from a first stocker to a first port in a processing tool.

In response to the move command, a vehicle may be dispatched to a source location to retrieve the material that is to be delivered to the destination location. Once the vehicle arrives at the source location, the requested carrier is loaded onto the vehicle and transported to the destination location. For example, a carrier stored in a stocker may be loaded onto a vehicle and transported to a load port of a processing tool. The carrier may then be unloaded at the destination location. If the destination location is not vacant, e.g. the destination location is an occupied load port, a handshake error may be provided to the AMHS, which may then retry delivery after a selected period of time. If the delivery is not successful after a selected number of attempts, the carrier may be transported to an alternate destination, such as the stocker.

Conventional material control system host interfaces only support move commands that indicate the carrier (or other material) that is to be moved and the source and destination locations for the carrier. However, the material control system host interface does not support move commands that may indicate timing of the move from the source to the destination location. Thus, if the material control system determines that the requested resources, carrier, and destination load port are available, the material control system will execute the move request from the manufacturing execution system immediately and dispatch a vehicle to the source location to retrieve the requested carrier. The staging time for moving the empty vehicle to the source location may be as short as approximately 10 seconds or as long as approximately 5 minutes, depending on the location of the empty vehicle at the time of the move request. Consequently, the requested material will not arrive at the destination location for at least the staging time plus any additional transport time from the source to the destination location. This delay may reduce the efficiency of the manufacturing facility.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for scheduling material transport in a semiconductor manufacturing facility. The method includes receiving a request to move material from a first location to a second location in the semiconductor manufacturing facility, accessing information indicative of a duration of the move from the first location to the second location, and scheduling the requested move based on the information indicative of the duration of the move. An apparatus and a semiconductor manufacturing facility that implement embodiments of the method are also provided.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a semiconductor manufacturing facility, in accordance with the present invention;

FIG. 2 conceptually illustrates a first exemplary embodiment of an automated material handling system control unit, in accordance with the present invention;

FIG. 3 conceptually illustrates one exemplary embodiment of a class diagram that may be implemented in the first exemplary embodiment of the automated material handling system control unit shown in FIG. 2, in accordance with the present invention;

FIG. 4 conceptually illustrates one exemplary embodiment of a transport job record, in accordance with the present invention;

FIG. 5 conceptually illustrates a second exemplary embodiment of an automated material handling system control unit, in accordance with the present invention;

FIG. 6 conceptually illustrates one exemplary embodiment of a method of caching information that may be used to schedule material transport in a semiconductor manufacturing facility, in accordance with the present invention; and

FIG. 7 conceptually illustrates the time savings produced by scheduling future material transport in a semiconductor manufacturing facility, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

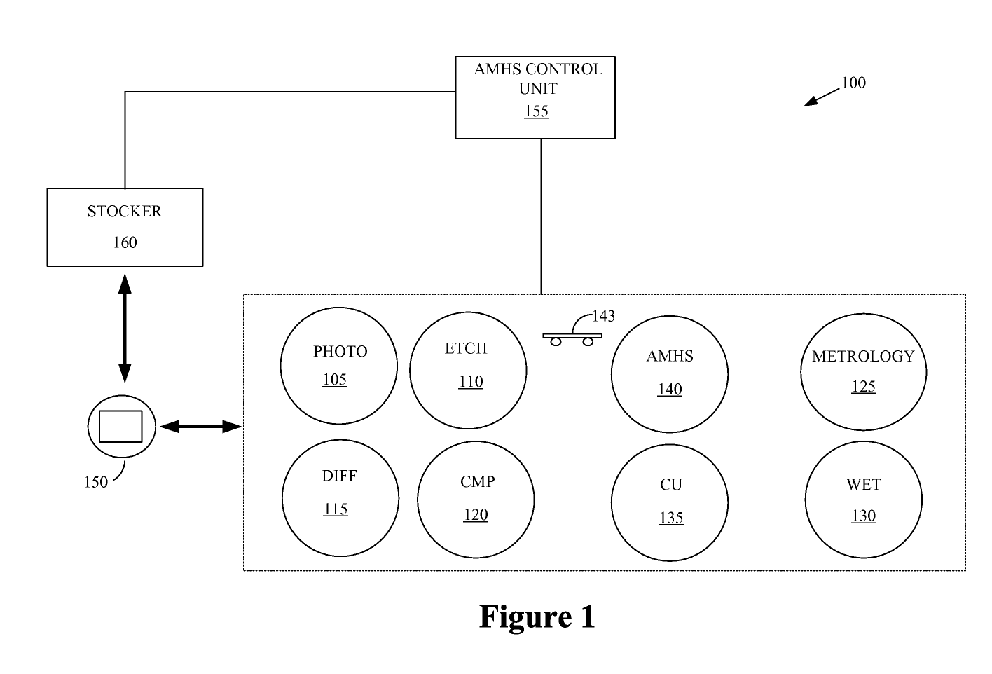

FIG. 1 conceptually illustrates one exemplary embodiment of a semiconductor manufacturing facility 100. In the interest of clarity, the various elements and/or components of a semiconductor manufacturing facility 100 will be depicted in schematic block diagrams. The physical layout of the manufacturing facility 100 will not necessarily correspond to the layout depicted in FIG. 1. The various interconnections between the elements and/or components will also be schematically depicted using arrows. The physical layout of the manufacturing facility 100, as well as the physical, communicative, and/or electrical interconnections between portions of the manufacturing facility 100, are considered matters of design choice and are not material to the present invention. Persons of ordinary skill in the art having benefit of the present disclosure should be able to implement specific layouts and the appropriate interconnections of the elements and/or components of the manufacturing facility 100 described herein.

In the illustrated embodiment, the manufacturing system 100 includes various processing tool groups such as groups of photolithography steppers 105, etch tools 110, diffusion tools 115, chemical mechanical polishing (CMP) tools 120, and the like. In the interest of clarity, only a few processing tool groups are depicted in FIG. 1. However, persons of ordinary skill in the art having benefit of the present disclosure should appreciate that the present invention is not limited to the processing tool groups 105, 110, 115, 120. In alternative embodiments, the manufacturing system 100 may include other tools or tool groups including, but not limited to, ion implantation tools, rapid thermal annealing tools, and the like. The manufacturing system 100 may also include groups of metrology tools 125 (e.g., scatterometers, ellipsometers, and the like) and/or wafer electrical testing tools 130. Each of the groups 105, 110, 115, 120, 125, 130 may include one or more individual tools (not shown), as well as one or more tool controllers (not shown) that may be used to control operation of the tools within each group 105, 110, 115, 120, 125, 130.

The illustrated manufacturing system 100 also includes a central utilities (CU) system 135, which may be used to provide materials to the tools in the processing tool groups 105, 110, 115, 120. For example, the central utilities system 135 may be used to provide consumable materials, such as process gases, process liquids, electrical power, chemical mechanical polishing pads, polishing slurry, spare parts, test or qualification wafers, process kit changes, etc. The illustrated manufacturing system 100 may also include an automated material handling system (AMHS) 140 to provide materials (such as wafers or wafer lots) to the various processing, metrology, and/or electrical testing tool groups 105, 110, 115, 120, 125, 130 or the individual tools located therein, when demanded by or scheduled for processing by one or more of the tools in one or more of the processing, metrology, and/or electrical testing tool groups 105, 110, 115, 120, 125, 130. In one embodiment, the automated material handling system 140 may comprise a plurality of vehicles 143, such robots or moveable carriers, which are adapted to transport material, such as wafers or a lot of wafers, to various locations within the manufacturing facility 100. For example, the vehicle 143 may travel along a system of rails or guides that link the tool groups 105, 110, 115, 120, 125, 130, the AMHS 140 and the CU 135.

In operation, one or more workpieces (e.g., wafers or wafer lots) 150 may be processed by the manufacturing system 100 to form one or more products in or on the workpieces 150. For example, the automated material handling system 140 may provide workpieces 150 to the various tool groups 105, 110, 115, 120, 125, 130 or the individual tools located therein, when demanded by or scheduled for processing, as discussed in detail below. The workpieces 150 may be processed and/or monitored by one or more of the tools in the tool groups 105, 110, 115, 120, 125, 130 using materials provided by the central utilities system 130 in accordance with an operating recipe. For example, the workpiece 150 may be provided to tools in the groups 105, 110, 115, 120, 125, 130 which may then form one or more gate electrode structures in or on the workpiece 150, in accordance with one or more operating recipes that may be provided to the tool groups 105, 110, 115, 120, 125, 130. Techniques for processing the workpieces 150 in the manufacturing system 100 to form various structure and/or products in or on the workpieces 150 are known to persons of ordinary skill in the art and, in the interest of clarity, only those aspects of processing the workpieces 150 that are relevant to the present invention will be discussed further herein.

In the illustrated embodiment, the manufacturing system 100 includes an automated materials handling system (AMHS) control unit 155. The AMHS control unit 155 is configured to control the automated material handling system 140 so that workpieces 150 may be provided to the various tool groups 105, 110, 115, 120, 125, 130 or the individual tools located therein, when demanded by or scheduled for processing by one or more of the tools in one or more of the tool groups 105, 110, 115, 120, 125, 130, as discussed in detail below. The AMHS control unit 155 may also be configured to control or regulate the provision of various consumable materials that may be needed by the various processing tool groups 105, 110, 115, 120, 125. For example, such materials may include process gases, process liquids, electrical power, chemical mechanical polishing pads, polishing slurry, spare parts, test or qualification wafers, process kit changes, etc. In one embodiment, the AMHS control unit 155 may also be configured to receive information (such as requests for workpieces and/or consumable materials) from the tool groups 105, 110, 115, 120, 125, 130, as well as individual tools or controllers located therein. The AMHS control unit 155 may use the received information to provide materials (such as workpieces and/or consumable materials) to the processing tool groups 105, 110, 115, 120, 125, 130. The workpieces 150 and/or the consumable materials may be provided by the central utilities system 135.

The manufacturing system 100 may also include a stocker 160 that may be used to store workpieces 150 before, during, and/or after processing of the workpieces 150 in the manufacturing system 100. For example, the stocker 160 may be configured to store workpieces 150 in carriers (not shown) so that the workpieces 150 may be retrieved from the stocker 160 and provided to one or more of the tools 105, 110, 115, 120, 125, 130, e.g. using the vehicle 143. The workpieces 150 may also be provided to the stocker 164 storage before, during, and/or after processing of the workpieces 150 in the manufacturing system 100. Accordingly, the AMHS control unit 155 may be configured to control the stocker 160 to coordinate provision and/or reception of the appropriate workpieces 150. The structure and operation of such stockers 160 are well known to those skilled in the art and in the interest of clarity will not be described in detail herein.

In operation, the AMHS control unit 155 may receive a request to move material, such as a wafer or a carrier that carries one or more wafers or wafer lots 150, from one location to another within the manufacturing facility 100. For example, one of the tools 105, 110, 115, 120, 125, 130 may request a carrier that contains wafers to be processed using the requesting tool. The request may indicate that the tool 105, 110, 115, 120, 125, 130 has a tool port that is currently ready to receive the requested carrier or will be ready to receive the requested carrier at a later time. If the tool port is currently ready to receive the requested carrier, then the AMHS control unit 155 may provide a signal or message to the AMHS 140 indicating that the requested carrier should be transported to the tool port as soon as possible. In this case, the tool port may not receive the requested carrier until after a move duration has elapsed. For example, the move duration may include the staging time for the vehicle 143.

If the request indicates that the tool 105, 110, 115, 120, 125, 130 has a port that will be ready to receive the requested carrier at a later time, then the AMHS control unit 155 may schedule a time for the requested carrier to be provided to the requesting tool port. In one embodiment, the expected duration of the requested move between a first and second location may be estimated or determined and then used to schedule the move. For example, an agent application (not shown in FIG. 1) may request an estimate of the expected duration of the requested move. An entity within the control unit 155 may then access previously stored records in a database for information that may be used to estimate the move duration. Exemplary information that may be stored in the records in the database may include a staging time for previous moves between the first and second locations, a delivery time for previous moves between the first and second locations, a start time for processing of the wafers on the requested carrier, an end time for processing the wafers, a move status (such as canceled, delayed, rerouted, and completed), a duration of a previous move between the first and second locations, a statistical representation of a duration of the requested move (e.g., an average value of durations of previous moves and a standard deviation of the durations) between the first and second locations, and the like. This information may be used to estimate the duration of the requested move and this estimate may be provided to the agent application, as will be discussed in detail below.

The AMHS control unit 155 may then schedule the requested move based on the determined or estimated duration of the requested move. For example, the AMHS control unit 155 may then schedule the requested move so that the vehicle 143 is dispatched to retrieve the workpiece 150 from the stocker 160 in time to deliver the workpiece 152 the requesting tool port at approximately the time the tool becomes available to process the new workpiece 150. Unproductive delays in processing that may result when tool ports have to wait for workpieces 150 to be delivered may therefore be reduced, thereby increasing the overall efficiency of the manufacturing system 100.

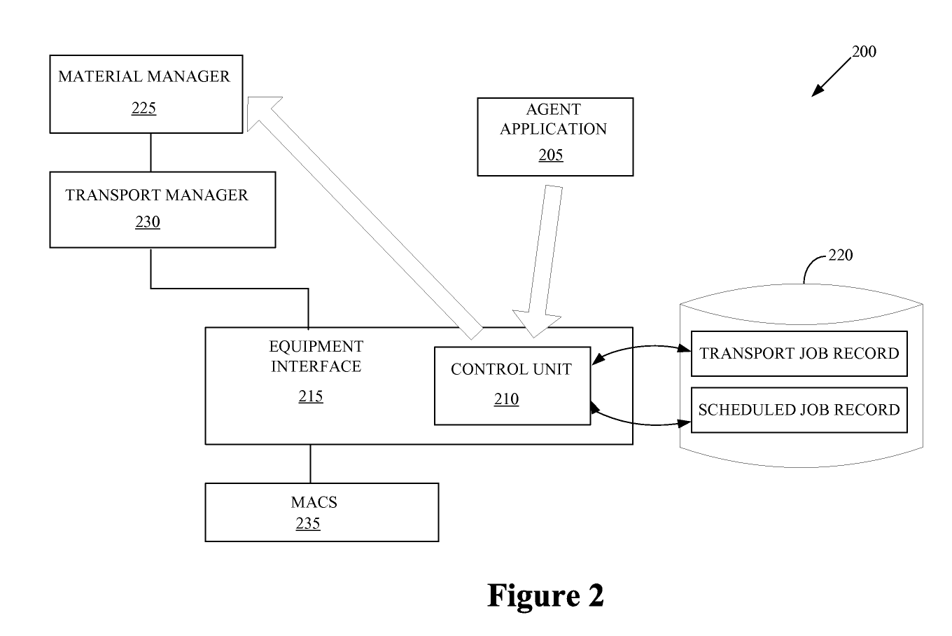

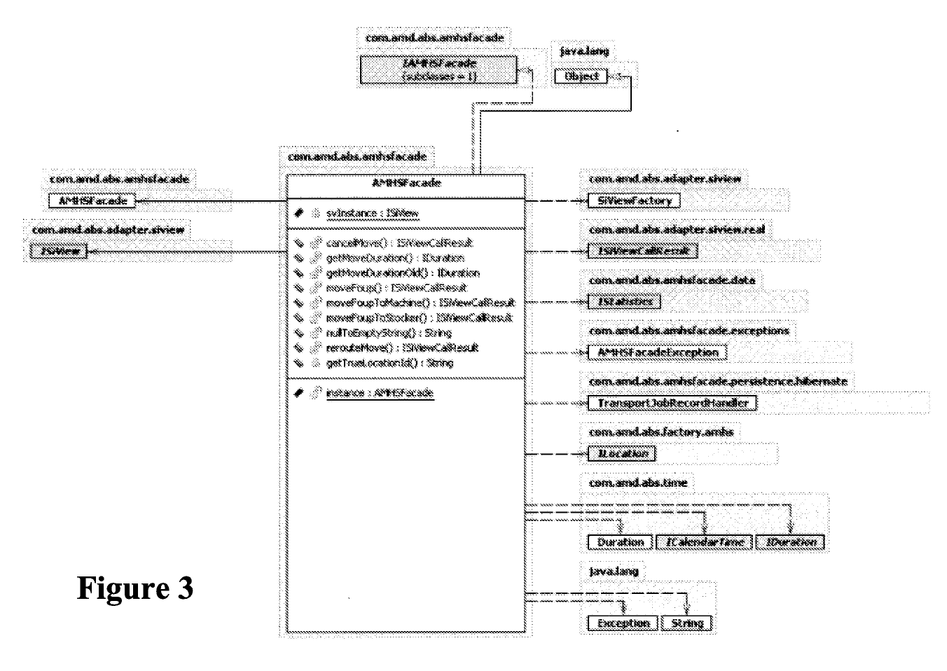

FIG. 2 conceptually illustrates a first exemplary embodiment of an automated material handling system control unit 200. In the illustrated embodiment, the automated material handling system control unit 200 includes an agent application 205 that may receive requests for future moves and may provide these requests to a control unit 210, such as the control unit 210 shown in FIG. 2. One exemplary embodiment of a class diagram for the control unit 210 is shown in FIG. 3. In the first exemplary embodiment, the control unit is incorporated within an equipment interface 215 (such as an AMHS-EI), which may implement architectures and/or protocols such as the Common Object Request Broke her Architecture (CORBA), the Message Queue/Simple Object Access Protocol (MQ/SOAP), components for handling basic Front-Opening Unified Pod (FOUP) and/or reticle moves, and the like. These architectures, protocols, and/or components may be implemented in hardware, firmware, software, or any combination thereof.

The control unit 210 may schedule the move using information indicative of a duration of the move. In one embodiment, requests for moves scheduled for the future may be queued and then initiated by issuing a move command in advance to account for the required vehicle staging time. The move commands provided by the control unit 210 may have a pickup time and drop-off time specified. The pickup time may be specified as a time window bounded by an earliest possible pickup time (i.e., the pickup is NOT allowed before the earliest possible pickup time) and a latest possible pickup time. Thus, a worst case scenario would be that the vehicle has to wait somewhere (w/o blocking the destination load port) before picking up the carrier at the latest possible pickup time The control unit 210 may keep track of the staging time for each individual pickup location, a delivery time from any source to any destination, a start time from any source to any destination, a move status, and the like. The control unit 210 may also notify the user in case of failure

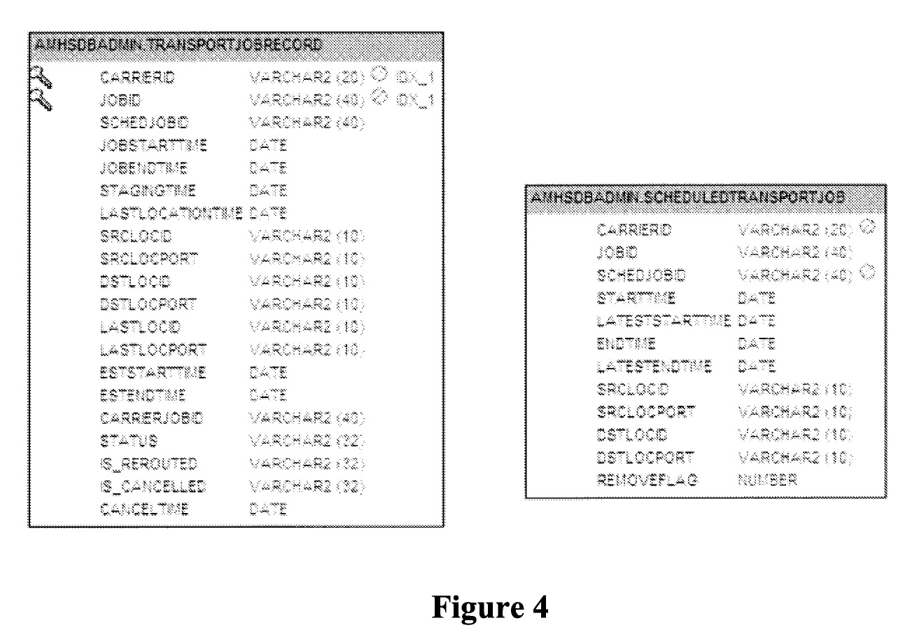

In the illustrated embodiment, the control unit 210 accesses the information indicative of the duration of the move from one or more transport job records in a database 220 (such as an AMHS-DB). The transport job records may include a variety of information associated with previous moves that may be used to determine the duration of the move or to characterize the likely duration of the move using one or more statistical measures. One exemplary embodiment of a transport job record is shown in FIG. 4. The fields shown in the exemplary embodiment of the transport job record are:

CARRIERID VARCHAE(20 BYTE) NOT NULL,
= The carrier id as identified in MES.
JOBID VARCHAR2(40 BYTE),
= The XM job Id
SCHEDJOBID VARCHAE(40 BYTE),
= The scheduled job ID; if exists
JOBSTARTTIME DATE,
= The start time as declared by the MES
JOBENDTIME DATE,
= The end time as declared by the MES
STAGINGTIME DATE,
= The time when the vehicle arrived at the starting location
LASTLOCATIONTIME DATE,
= The date at the last location
SRCLOCID VARCHAR2(10 BYTE),
= The start location of the move
SRCLOCPORT VARCHAR2(10 BYTE),
= The port of the start location
DSTLOCID VARCHAW(10 BYTE),
= The end location
DSTLOCPORT VARCHAR2(10 BYTE),
= The port of the end location
LASTLOCID VARCHAW(10 BYTE),
= The last location of the vehicle
LASTLOCPORT VARCHAW(10 BYTE),
= The last port of the vehicle
ESTSTARTTIME DATE,
= Estimated time of start job
ESTENDTIME DATE,
= Estimated time of end job
CARRIERJOBID VARCHAR2(40 BYTE),
= The job id as provided by MES
STATUS VARCHAW(32 BYTE),
= The status of the job: the values can be names: “COMPLETED”,
“REROUTED”,
“CANCELLED” and “ABORTED”
IS REROUTED VARCHAR2(32 BYTE),
= Rerouted flag
IS CANCELLED VARCHAW(32 BYTE),
= cancelled flag
CANCELTIME DATE
= Cancel time

The computed scheduling information may then be saved, e.g., in the database 220 as a scheduled transport job record. One exemplary embodiment of a scheduled job record is shown in FIG. 4. The fields shown in the exemplary embodiment of the scheduled job record are:

CARRIERID VARCHAR2(20 BYTE) NOT NULL,
= The carrier id as identified in MES
JOBID VARCHAR2(40 BYTE),
= The XM job Id
SCHEDJOBID VARCHAE(40 BYTE) NOT NULL,
= The scheduled job id; each future job has a unique job
id prior to the move
STARTTIME DATE,
= The start time of the future job
LATESTSTARTTIME DATE,
= The desired start time of the future job
ENDTIME DATE,
= The end time of the future job
LATESTENDTIME DATE,
= The desired end time of the future job
SRCLOCID VARCHAR2(10 BYTE),
= The start location of the move
SRCLOCPORT VARCHAE(10 BYTE),
= The port of the start location
DSTLOCID VARCHAR2(10 BYTE),
= The end location
DSTLOCPORT VARCHAE(10 BYTE),
= The port of the end location
REMOVEFLAG INTEGER
= The job was scheduled to be removed

The control unit 210 may initiate the scheduled move at the scheduled time by providing a signal and/or message. In the illustrated embodiment, the control unit 210 initiates the scheduled FOUP move by providing a message to material manager 225. The material manager 225 may then execute the scheduled move via a transport manager 230, the equipment interface 215, and a MACS 235 by providing conventional messages and/or signals in response to the signaling and/or message is provided by the control unit 210 at the scheduled time.

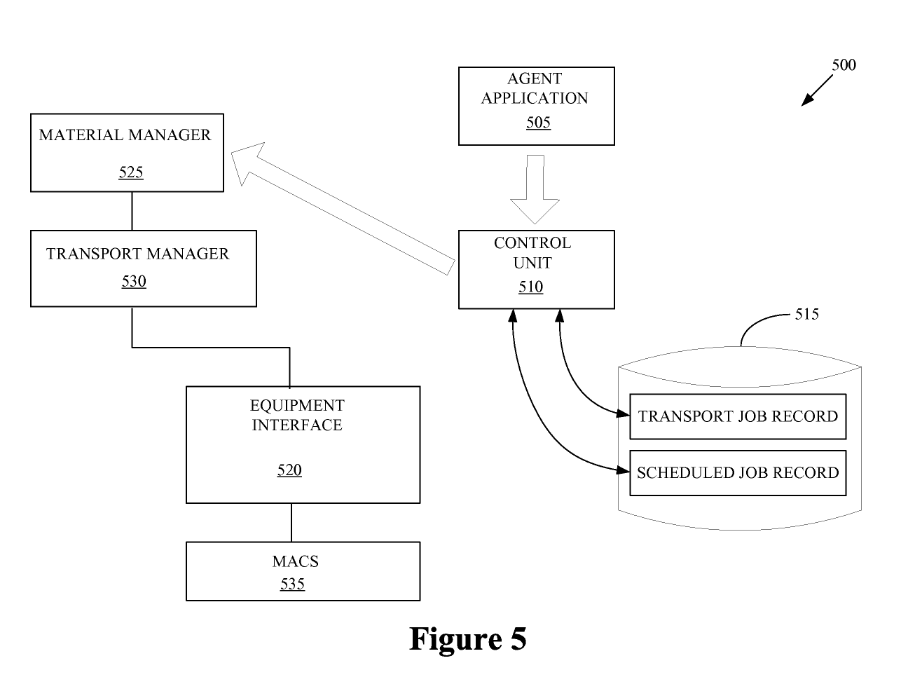

FIG. 5 conceptually illustrates a second exemplary embodiment of an automated material handling system control unit 500. In the illustrated embodiment, the automated material handling system control unit 500 includes an agent application 505 that may receive requests for future moves and may provide these requests to a control unit 510. The control unit 510 may then schedule the move using information indicative of a duration of the move. In the illustrated embodiment, the control unit 510 accesses this information from a transport job record of a database 515. As discussed above, the transport job record may include a variety of information that may be used to determine the duration of the move or to characterize the likely duration of the move using one or more statistical measures. The computed scheduling information may then be saved, e.g., in the database 515 as a scheduled transport job record. The second exemplary embodiment differs from the first exemplary embodiment in that the control unit 510 and the database 515 are not incorporated within the equipment interface 520.

As discussed above, the control unit 510 may initiate the scheduled move at the scheduled time by providing a signal and/or message. In the illustrated embodiment, the control unit 510 initiates the scheduled FOUP move by providing a message to the materials manager 520, which may then execute the scheduled move via a transport manager 525, the equipment interface 530, and a MACS 535 by providing conventional messages and/or signals in response to the signaling and/or messages provided by the control unit 510 at the scheduled time.

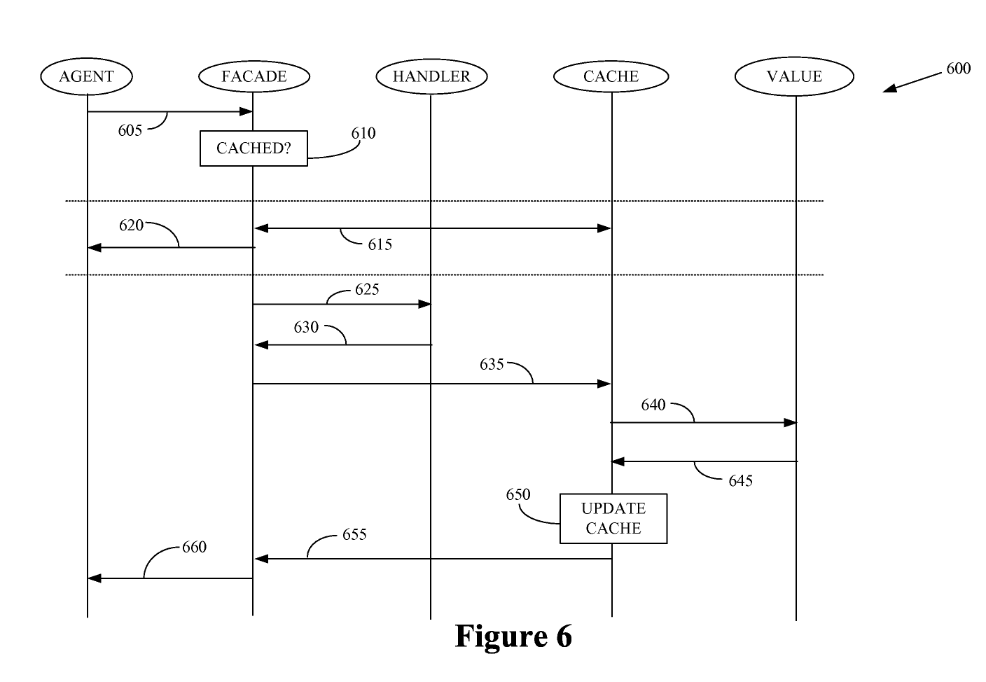

FIG. 6 conceptually illustrates one exemplary embodiment of a method 600 of caching information that may be used to schedule material transport in a semiconductor manufacturing facility. In the illustrated embodiment, the control unit (Façade) receives a request for an estimate of a move duration from an agent application (AGENT), as indicated by the arrow 605. The control unit attempts to determine (at 610) whether or not the requested move duration is currently stored in the cache (CACHE). If the information is stored in the cache, then the control unit retrieves the value from the cache, as indicated by the arrow 615 and returns the value of the move duration to the agent application, as indicated by the arrow 620. If the requested value is not stored in the cache, then the control unit requests (as indicated by the arrow 625) information that may be used to compute a move duration from one or more transport job records in a database, e.g. using the transport job record handler, which may return (as indicated by the arrow 630) the requested values to the control unit.

The duration of the move, or a statistical representation of the duration of the move, may be computed and provided to the cache, as indicated by the arrow 635. In one embodiment, the cache may use the provided move duration to determine a quantile of the value of the move duration using other values of the move duration stored in the cache, as indicated by the arrow 640. The value of the quantile may then be returned, as indicated by the arrow 645, and used to update (at 650) the cache. The computed values may then be returned to the control unit, as indicated by the arrow 655, which may return the requested value to the agent application, as indicated by the arrow 660. For example, in one embodiment, an AMHS-EI is responsible for updating a database. When a move is issued, the AMHS-EI may insert a new record into the database. While the move is progressing, the AMHS-EI may update the database with the status of the move. This information can then be used by the control unit AMHSFacade to compute move durations. The AMHSFacade system may compute statistics with the duration between two locations and maintain that information in the cache. Each time a duration of a move between location A and B is requested, the system checks the cache first. If a result is there, it is returned. If the result cannot be found in the cache, then the control unit AMHSFacade may read a selected number of values from the database, compute statistics, and update the cache with this new value. The cache may have an aging policy so that old records get purged from the cache after a configurable period of time. The statistical computation is based on the mathematical standard 90 quantiles.

Implementing a cache may reduce the time required to determine a move duration and may therefore increase the efficiency of a semiconductor manufacturing facility. However, persons of ordinary skill in the art having benefit of the present disclosure should appreciate that the present invention is not limited to embodiment that implements a cache and, in alternative embodiments, no cache may be used.

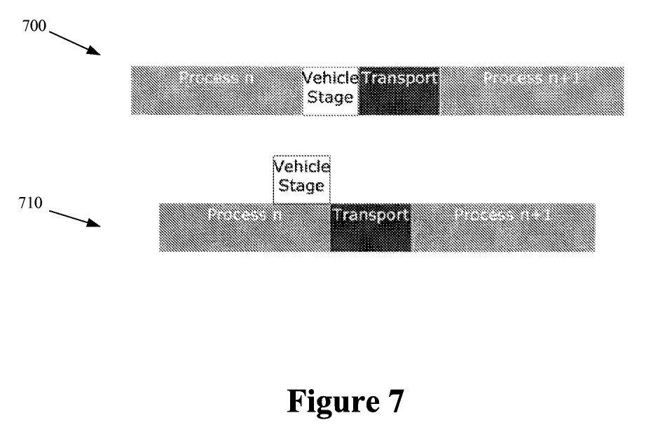

FIG. 7 conceptually illustrates the time savings produced by scheduling future material transport in a semiconductor manufacturing facility. In the conventional approach illustrated by the timeline 700, a first process completes and then a move request is issued so that material may be transported to the appropriate tools for the next process. Consequently, the total elapsed time between completion of the first process and beginning the second process includes both the vehicle staging time and a transport time. However, embodiments of the scheduling technique described above may estimate the move duration in order to schedule moves in advance. For example, the move duration may be determined based on previous historical move times so that the AMHS system can provide an estimate of a move duration for a move between two locations. The AMHS system may then keep track of the future scheduled moves and execute them at the specified time. Consequently, the move may be scheduled so that the vehicle may be dispatched to retrieve the requested materials prior to completion of the first process, thereby reducing the elapsed time between the first and second processes, as shown in the exemplary timeline 710.

Moreover, embodiments of the system described above provide an infrastructure that may be used to evaluate the performance of the AMHS systems. For example, engineers may access the information stored in the database and/or the cache to analyze the moves that have been performed within the manufacturing system. This analysis may be used to improve operation of the manufacturing system and, in particular, scheduling of future moves.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
receiving a request to move material from a first location to a second location in a semiconductor manufacturing facility;
accessing information indicative of a duration of the move from the first location to the second location; and
scheduling the requested move based on the information indicative of the duration of the move.

2. The method of claim 1, wherein receiving the request to move material comprises receiving a request to move at least one wafer.

3. The method of claim 2, wherein receiving the request to move said at least one wafer comprises receiving a request to move at least one carrier including said at least one wafer.

4. The method of claim 3, wherein receiving the request to move said at least one carrier from a first location to a second location comprises at least one of receiving a request to move said at least one carrier from a stocker to a tool port and receiving a request to move said at least one carrier from a tool port to a stocker.

5. The method of claim 1, wherein accessing said information indicative of the duration of the move comprises accessing said information from at least one of a database and a cache.

6. The method of claim 5, wherein accessing said information comprises accessing at least one of a staging time, a delivery time, a start time, an end time, a move status, a duration of a previous move from the first location to the second location, and a statistical representation of a duration of a move from the first location to the second location.

7. The method of claim 5, wherein accessing said information comprises accessing said information from a database and determining at least one of a move duration and a statistical representation of the move duration based on said information.

8. The method of claim 7, comprising storing said at least one determined move duration or statistical representation of the move duration in the cache.

9. The method of claim 1, wherein scheduling the requested move comprises determining at least one pickup time for retrieving material from the first location.

10. The method of claim 9, wherein determining said at least one time comprises determining at least one of an earliest possible pickup time and a latest possible pickup time.

11. The method of claim 9, comprising storing information indicative of said at least one pickup time in a database.

12. The method of claim 9, comprising providing a request to dispatch a vehicle to retrieve the material from the first location at said at least one pickup time.

13. The method of claim 12, comprising dispatching the vehicle at approximately said at least one pickup time.

14. An apparatus, comprising:
means for receiving a request to move material from a first location to a second location in a semiconductor manufacturing facility;
means for accessing information indicative of a duration of the move from the first location to the second location; and
means for scheduling the requested move based on the information indicative of the duration of the move.

15. A semiconductor fabrication facility, comprising:
a first location and a second location; and
an automated material handling system configured to:
receive a request to move material from the first location to the second location;
access information indicative of a duration of the move from the first location to the second location; and
schedule the requested move based on the information indicative of the duration of the move.

16. The semiconductor fabrication facility of claim 15, wherein the automated material handling system is configured to receive a request to move at least one wafer.

17. The semiconductor fabrication facility of claim 16, wherein the automated material handling system is configured to receive a request to move at least one carrier including said at least one wafer.

18. The semiconductor fabrication facility of claim 15, wherein the first location comprises at least one of a stocker and a tool port and wherein the second location comprises at least one of a tool port and a stocker.

19. The semiconductor fabrication facility of claim 15, wherein the automated material handling system is configured to access at least one of a staging time, a delivery time, a start time, an end time, a move status, a duration of a previous move from the first location to the second location, and a statistical representation of a duration of a move from the first location to the second location.

20. The semiconductor fabrication facility of claim 15, further comprising at least one of a database and a cache and wherein the automated material handling system is configured to access said information from at least one of the database and the cache.

21. The semiconductor fabrication facility of claim 20, wherein the automated material handling system is configured to access said information from the database and determine at least one of a move duration and a statistical representation of the move duration based on said information.

22. The semiconductor fabrication facility of claim 21, wherein the automated material handling system is configured to store said at least one determined move duration or statistical representation of the move duration in the cache.

23. The semiconductor fabrication facility of claim 15, wherein the automated material handling system is configured to determine at least one pickup time for retrieving material from the first location.

24. The semiconductor fabrication facility of claim 23, wherein the automated material handling system is configured to determine at least one of an earliest possible pickup time and a latest possible pickup time.

25. The semiconductor fabrication facility of claim 24, wherein the automated material handling system is configured to store information indicative of said at least one pickup time in a database.

26. The semiconductor fabrication facility of claim 15, further comprising at least one vehicle for transporting material and wherein the automated material handling system is configured to provide a request to dispatch the vehicle to retrieve the material from the first location at said at least one pickup time.
